(19) United States
(12) Patent Application Publication
(10) Pub. No.: US 2003/0178086 A1
(43) Pub. Date: Sep. 25, 2003

(54) Cable protection sleeve and cable insertion device for inserting cables therein

(75) Inventor: Guohai Hu, Cixi Ningbo (CN)

Correspondence Address: Vasilios D. Dossas, NIRO, SCAVONE, HALLER & NIRO, Suite 4600, 181 West Madison, Chicago, IL, 60602, US

(73) Assignee: YUET MENG TRADING CO (PTE) LTD

(21) Appl. No.: 10/375,627

(22) Filed: Feb. 26, 2003

(30) Foreign Application Priority Data
Mar. 25, 2002 (CN) 02230210.7

(51) Int. Cl. F16L 11/00

(52) U.S. Cl. 138/156; 138/110; 138/166; 138/167

(57) ABSTRACT

A cable insertion device for facilitating the insertion of one or more cables into a resilient tubular cable protection sleeve having a slit along the length thereof, the cable insertion device comprising a cable guiding portion, having first and second open ends, for guiding one or more cables during insertion thereof into a cable protection sleeve, the arrangement being such that, in an engaged state of the cable insertion device and the cable protection sleeve, one of the first and second open ends is substantially within the cable protection sleeve and the other of the first and second open ends is substantially outside the cable protection sleeve, so that relative motion of the cable insertion device and the cable protection sleeve inserts one or more cables received in the cable guiding portion into the cable protection sleeve. Also disclosed is a cable protection sleeve comprising a tube of a resilient material, the tube having a slit along the length thereof, the arrangement being such that, in a resting state, the edges of the slit overlap one another.

### BACKGROUND OF THE INVENTION

This invention relates to a cable protection sleeve, and particularly relates to a cable protection sleeve that is simple to use and readily allows insertion, removal and inspection of cables.

It is a common problem when using, for instance, electrical equipment, to have a large number of cables, wires or tubes for connecting items of the electrical equipment to one another or to power supplies, data connections and so forth. The presence of many such cables can be unsightly, untidy and in some cases dangerous, for example if the cables are in a location where they may be tripped over. The cables may also be prone to damage, if they are stepped on.

Conventional solutions to this problem include the encasing of the cables inside a length of sealed hose or casing. However, this technique suffers from certain drawbacks. It is time-consuming to thread a number of cables into such a length of such sealed casing, and to remove one or more of the cables for replacement or inspection, or if one of the items of electrical equipment is to be moved. Also, a standard diameter of sealed casing is likely to be, in general, too large or small for a user's cables, and hence the casing will either be too large, in which case the casing is unlikely to hold the cables in place effectively, or too small, in which case some cables will not be accommodated in the tubing.

### SUMMARY OF THE INVENTION

It is an object of the present invention to seek to alleviate some or all of the above drawbacks.

Accordingly, one aspect of the present invention provides a cable insertion device for facilitating the insertion of one or more cables into a resilient tubular cable protection sleeve having a slit along the length thereof, the cable insertion device comprising a cable guiding portion, having first and second open ends, for guiding one or more cables during insertion thereof into a cable protection sleeve, the arrangement being such that, in an engaged state of the cable insertion device and the cable protection sleeve, one of the first and second open ends is substantially within the cable protection sleeve and the other of the first and second open ends is substantially outside the cable protection sleeve, so that relative motion of the cable insertion device and the cable protection sleeve inserts one or more cables received in the cable guiding portion into the cable protection sleeve.

Advantageously, the cable insertion device further comprises a grip portion to be gripped by a user during relative motion of the cable insertion device and the cable protection sleeve.

Preferably, the grip portion is formed integrally with the cable guiding portion. Conveniently, the grip portion is moveable with respect to the cable guiding portion. Advantageously, the cable guiding portion comprises a substantially tubular element. Preferably, the cable insertion device further comprises a protrusion configured such that, in an engaged state of the cable insertion device and the cable protection sleeve, the protrusion lies substantially within the cable protection sleeve.

Conveniently, a free end of the protrusion is substantially conical.

Advantageously, a longitudinal axis of the conical free end of the protruding head is substantially parallel with the longitudinal axis of the cable protection sleeve, in the region of the cable insertion device, in an engaged state of the cable insertion device and the cable protection sleeve.

Preferably, the protrusion is formed integrally with the cable guiding portion. Another aspect of the present invention provides a cable protection sleeve comprising a tube of a resilient material, the tube having a slit along the length thereof, the arrangement being such that, in a resting state, the edges of the slit overlap one another.

Conveniently, the cable protection sleeve comprises spaced apart notches in the tube in a direction perpendicular to a longitudinal axis of the tube.

Advantageously, at least some of the notches are formed in an edge of the slit.

Preferably, at least some of the notches do not meet either edge of the slit.

A further aspect of the present invention provides a cable protection sleeve according to the above, in combination with a cable insertion device according to the above.

### BRIEF DESCRIPTION OF THE DRAWINGS

In order that the present invention may be more readily understood, embodiments thereof will now be described, by way of example, with reference to the accompanying drawings, in which:

FIG. 1 shows a part of a cable protection sleeve embodying the present invention;

FIG. 2 shows a cross-section of the cable protection sleeve of FIG. 1;

FIG. 3 shows a cable insertion device embodying the present invention;

FIG. 4 shows a sectional view of the cable insertion device of FIG. 3 taken through line 4-4;

FIG. 5 shows a plan view of an alternative cable insertion device embodying the present invention; and

FIG. 6 shows a plan view of the cable insertion device of FIG. 3.

### DETAILED DESCRIPTION OF THE DRAWINGS

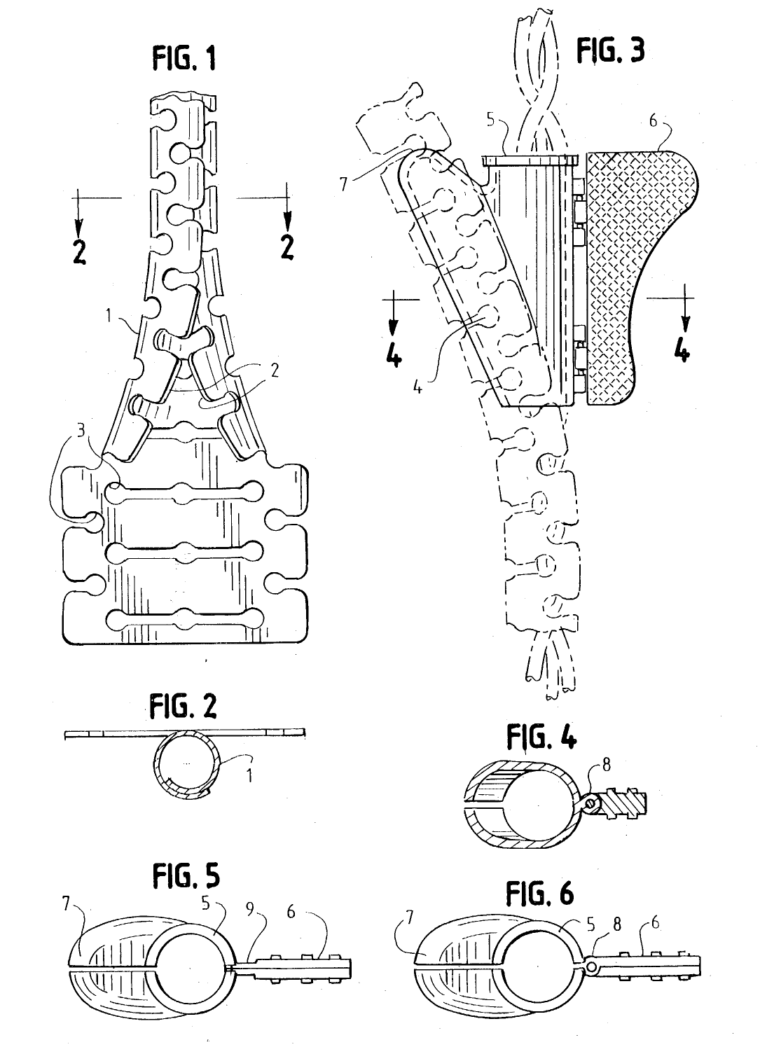

Referring to FIG. 1, a cable protection sleeve 1 embodying the present invention comprises a tube of a resilient material, the tube having a slit along the length thereof. The tube may be formed from a sheet of the resilient material that is rolled to form the tube, or alternatively the cable protection sleeve 1 may be formed from the resilient material in the form of a tube. In either case, the cable protection sleeve 1 is formed so that, in a resting state, the edges 2 of the slit overlap one another.

This overlapping can be clearly seen from the cross-sectional view of the cable protection sleeve 1 given in FIG. 2. In a preferred embodiment, the overlap is such that between 20° and 45° of the circumference of the tube, taken around the longitudinal axis of the tube, comprises a double thickness of the resilient material.

It will be noted that, in FIG. 1, a portion of the tube comprising the cable protection sleeve 1 is unrolled to form a flat sheet. It will be understood that this is for illustrative purposes only, and a cable protection sleeve 1 embodying the present invention is preferably provided completely rolled into a tubular form, as described above.

The resilience of the material is preferably chosen so that the tube of the cable protection sleeve 1 can be readily opened up to allow the insertion of one or more cables, particularly with a specially adapted cable insertion device (described in detail below), but will be unlikely to open up during normal use. In addition, the tube of the cable protection sleeve 1 may expand to accommodate a bundle of cables of greater diameter than the resting diameter of the tube. Hence, the cable protection sleeve 1 may accommodate a variety of sizes of bundles of cables, and the resilience of the material from which the cable protection sleeve 1 is formed will cause the cable protection sleeve 1 to attempt to contract to the resting form thereof, and hence to grip the bundle of tubes. This gripping will reduce the likelihood of cables slipping along the length of the cable protection sleeve 1.

A series of notches 3 may be formed in the cable protection sleeve 1. These notches 3 are preferably formed in a direction substantially perpendicular to the longitudinal axis of the cable protection sleeve 1, and may be formed in the edges of the slit in the tube of the cable protection sleeve 1. Alternatively, or in addition to these notches 3, notches 3 may be formed which do not meet either edge of the slit. The notches 3 assist in making the cable protection sleeve 1 flexible, and also allow a user to see which cables are accommodated in the tube, as well as allowing a user to ascertain the condition of cables accommodated in the tube, without removing the cables there from. The notches 3 may also allow a particular wire to be drawn out from the cable protection sleeve 1 at any point along the length of the protection cable protection sleeve 1, and indeed various cables may branch away from the cable protection sleeve 1 at various points along the length thereof. The notches 3 also allow dissipation of heat from the cables.

FIG. 3 provides a cable insertion device 4 embodying the present invention. The cable insertion device may be used with the cable protection sleeve 1 described above, to insert one or more cables into the cable protection sleeve 1.

The cable insertion device 4 comprises a cable guiding portion 5, which is preferably in the form of a substantially tubular element having first and second open ends. The cable guiding portion 5 is used to guide one or more cables during insertion thereof into the cable protection sleeve 1. In preferred embodiments of the invention, the cable guiding portion 5 comprises two removably detachable halves, to allow easy placement of the cable guiding portion 5 around cables.

The cable insertion device 4 further comprises a grip portion 6, which is to be gripped by a user during use of the cable insertion device 4. The grip portion 6 is preferably substantially planar, of a suitable size to be gripped between a user's thumb and forefinger, and may be provided with a series of parallel or cross-hatched grooves to assist a user to grip the surfaces thereof.

The cable guiding portion 5 and the grip portion 6 are connected to one another, and preferably the connection is a flexible one. The cable guiding portion 5 and grip portion 6 may be connected by flexible connectors 8 (see FIGS. 3, 4 and 6) or by thin strips of material 9 comprising a living hinge (see FIG. 5). The cable guiding portion 5 and the grip portion 6 may be formed separately, or alternatively may be formed in a unitary fashion.

FIG. 4 shows a cutaway view of the cable insertion device 4 of FIG. 3, taken along the line 4-4 shown therein.

The cable insertion device 4 further comprises a projection 7, which projects from a side of the cable guiding portion 5 and is generally in the form of a cone, whose central axis subtends an angle to the central axis of the cable guiding portion 5. The tip of the cone lies beside the first open end of the cable guiding portion 5, and the base of the cone comprises the second open end of the cable guiding portion 5. It will be appreciated from the discussion below that the protrusion 7 may take any of a variety of forms, and the invention is not limited to cone-shaped projections.

The projection 7 is preferably formed in a unitary fashion with the cable guiding portion 5, but may be formed separately there from and joined thereto during manufacture of the cable insertion device 4.

In use of the cable insertion device 4, the cable guiding portion 5 is first placed around one or more cables, and this may be achieved by separating the two halves of the cable guiding portion 5 and re-attaching them around the cables. The user then grips the grip portion 6, and threads the free end of the projection 7 into an end of the cable protection sleeve 1. In this engaged state, the protrusion 7 and the second open end of the cable guiding portion 5 lie substantially within the cable protection sleeve 1, while the first open end of the cable guiding portion 5 and the grip portion 6 protrude there from through the slit.

The user then holds the end of the cable protection sleeve 1 into which the projection 7 was threaded, and pulls the grip portion 6 along the length of the slit in the cable protection sleeve 1. The cable guiding portion 5 guides the cables into the cable protection sleeve 1, and it will be understood that the projection 7 ensures that the first and second open ends of the cable guiding portion 5 remain respectively outside and within the cable protection sleeve 1 during this motion.

It will be understood that, while the slit will be opened in the region of the cable insertion device 4 as it is drawn along the cable protection sleeve 1, the tube of the cable protection sleeve 1 will be closed along the rest of the length of the cable protection sleeve 1.

Once the user has pulled the cable insertion device 4 along the entire length of the cable protection sleeve 1, the cables are threaded through the cable protection sleeve 1. It will be appreciated that this threading occurs as the user pulls the cable insertion device 4 along the length of the cable protection sleeve 1. The cables may then be removed from the cable guiding portion 5 of the cable insertion device 4, and again this may be achieved by detaching the two halves of the cable guiding portion 5 from one another.

It will be appreciated that the present invention provides a simple and useful method of gathering cables in a safe and tidy way, which readily allows the insertion, removal or replacement of a desired number of cables. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. A cable insertion device for facilitating the insertion of one or more cables into a resilient tubular cable protection sleeve having a slit along the length thereof, the cable insertion device comprising a cable guiding portion, having first and second open ends, for guiding one or more cables during insertion thereof into a cable protection sleeve, the arrangement being such that, in an engaged state of the cable insertion device and the cable protection sleeve, one of the first and second open ends is substantially within the cable protection sleeve and the other of the first and second open ends is substantially outside the cable protection sleeve, so that relative motion of the cable insertion device and the cable protection sleeve inserts one or more cables received in the cable guiding portion into the cable protection sleeve.

2. A cable insertion device according to claim 1, further comprising a grip portion to be gripped by a user during relative motion of the cable insertion device and the cable protection sleeve.

3. A cable insertion device according to claim 2, wherein the grip portion is formed integrally with the cable guiding portion.

4. A cable insertion device according to claims 2, wherein the grip portion is moveable with respect to the cable guiding portion.

5. A cable insertion device according to claim 1, wherein the cable guiding portion comprises a substantially tubular element.

6. A cable insertion device according to claim 1, further comprising a protrusion configured such that, in an engaged state of the cable insertion device and the cable protection sleeve, the protrusion lies substantially within the cable protection sleeve.

7. A cable insertion device according to claim 6, wherein a free end of the protrusion is substantially conical.

8. A cable insertion device according to claim 7, wherein a longitudinal axis of the conical free end of the protruding head is substantially parallel with the longitudinal axis of the cable protection sleeve, in the region of the cable insertion device, in an engaged state of the cable insertion device and the cable protection sleeve.

9. A cable insertion device according to claim 6, wherein the protrusion is formed integrally with the cable guiding portion.

10. A cable protection sleeve comprising a tube of a resilient material, the tube having a slit along the length thereof, the arrangement being such that, in a resting state, the edges of the slit overlap one another.

11. A cable protection sleeve according to claim 10, comprising spaced apart notches in the tube in a direction perpendicular to a longitudinal axis of the tube.

12. A cable protection sleeve according to claim 11, wherein at least some of the notches are formed in an edge of the slit.

13. A cable protection sleeve according to claim 11, wherein at least some of the notches do not meet either edge of the slit.
